(19) United States
(12) Patent Application Publication
(10) Pub. No.: US 2008/0152927 A1
(43) Pub. Date: Jun. 26, 2008

(54) Coating composition applicable to nonpolar resin substrate, multilayer coat forming method using the same, and coated resin product

(75) Inventors: Fumihito Noguchi, Aichi-ken (JP); Takashi Sekiya, Aichi-ken (JP); Hiroshi Watarai, Aichi-ken (JP); Sakae Matsui, Osaka-fu (JP); Makoto Hashimoto, Hirakata-city (JP); Takashi Morimoto, Osaka-fu (JP); Manabu Yamaoka, Hirakata-city (JP)

Correspondence Address: POSZ LAW GROUP, PLC, 12040 SOUTH LAKES DRIVE, SUITE 101, RESTON, VA, 20191, US

(73) Assignees: TOYODA GOSEI CO., LTD., Aichi-ken (JP); NIPPON BEE CHEMICAL CO., LTD., Osaka (JP)

(21) Appl. No.: 12/003,099

(22) Filed: Dec. 20, 2007

(30) Foreign Application Priority Data
Dec. 22, 2006 (JP) 2006-346467

(51) Int. Cl. B32B 27/40; C08F 2/48; C08L 27/00

(52) U.S. Cl. 428/423.1; 427/508; 525/76; 522/90

(57) ABSTRACT

A colored base coating composition includes a chlorinated polyolefin resin grafted with an acrylic component in which the acrylic component has a glass transition temperature (Tg) of 60° C. or more and an OH group-containing acrylic resin. The chlorinated polyolefin resin grafted with the acrylic component and the OH group-containing acrylic resin have a mass ratio of nonvolatile matters thereof ranging from 70/30 to 50/50. The colored base coating composition is applied on a substrate made of a nonpolar resin to form a colored base coat, and the coat is dried so that a nonvolatile matter of the coat becomes 70 to 100% by mass. A clear coating composition having a coating viscosity of 15 to 50 mPa·s is applied on the colored base coat to form the clear coat, and the clear coat is irradiated with an active energy ray in an atmosphere having an oxygen content of 5% by mass or less to be cured.

### TECHNICAL FIELD

The present invention relates to a coating composition applicable to a nonpolar resin substrate, a multilayer coat forming method using the coating composition and a coated resin product produced by applying the coating composition.

### BACKGROUND OF THE INVENTION

Recently, with respect to the automobile, lightweighting is actively attempted from the viewpoint of improving the fuel efficiency, and resin materials are very frequently applied to parts of the automobile. Above all, a polyolefin resin, such as polypropylene, is not only inexpensive, but also is excellent in physical properties, such as formability and chemical resistance, so that it is widely applied to parts of the automobile.

On the other hand, the automobile is used in various environments, so that needless to say, high weathering resistance is required for the automobile and it is also required that the automobile has also design properties as consumer goods. Automobile parts constituting the automobile also are necessary to have not only high weathering resistance, but also design properties, so that on the surface of such automobile parts, coating is performed.

Accordingly, also on the surface of automobile parts made of a resin, coating is naturally performed, and for securing a more satisfactory appearance of the coating, multilayer coating in which a surface coated with a colored base coating composition is further coated with a clear coating composition is performed. Additionally, an automobile part made of a nonpolar resin containing no hetero atom in the molecule thereof, such as a polyolefin resin, has generally poor adhesion with a top coating film, so that primer coating is performed before the coating of a colored base coating composition.

When as a clear coating composition of a multilayer coat, a so-called lacquer coating composition containing a solvent is used, it takes time to evaporate the solvent in the coat, so that not only a process time is lengthened, but also a load is imposed on the environment, when an organic compound is used as a solvent. Therefore, a clear coating composition containing no solvent or an active energy ray-curable clear coating composition having a small solvent content is proposed (Japanese Patent Application Publication Nos. JP-A-8-155381 and JP-A-6-63494).

On the other hand, when a primer coating is performed on a substrate made of a polyolefin resin, not only a process time is lengthened, but also one more additional step becomes necessary and consequently, the cost becomes higher. Accordingly, a so-called primerless coating which can be used without performing primer coating is proposed (Japanese Patent Application Publication No. JP-A-10-195370).

### SUMMARY OF THE INVENTION

Although an active energy ray-curable clear coating composition and a primerless coating composition for a polyolefin resin are individually proposed, a coating composition which is a primerless coating composition for a nonpolar resin, such as a polyolefin resin, and also is an active energy ray-curable clear coating composition is not yet proposed.

This is because of the following reason: while an active energy ray-curable clear coating composition contains a photopolymerizable monomer polymerized by irradiation with an active energy ray, in a primerless coating composition for a nonpolar resin, a large amount of a resin component contained in a primer is incorporated. Accordingly, when such an active energy ray-curable clear coating composition is applied on a coat of the primerless coating composition, by the photopolymerizable monomer contained in the clear coating composition, the coat of the primeness coating composition is eroded and the appearance (distinctness) thereof is impaired.

Thus, with respect to a coated resin product made of a nonpolar resin, such as a polyolefin resin, a satisfactory shortening of the time for a coating process has not yet been achieved.

An advantage of some aspects of the present invention is to provide a colored base coating composition that is applied on a substrate made of a nonpolar resin, such as a polyolefin resin, and that can provide a satisfactory coat surface by coating the substrate with an active energy ray-curable clear coating composition, without coating the substrate with a primer; a clear coating composition which will be applied on a coat formed by applying the colored base coating composition; and a multilayer coat forming method using these coating compositions; as well as to provide a coated resin product by which, using these coating compositions, a satisfactory shortening of the time for a coating process can be achieved.

In order to solve the aforementioned problems, the present invention includes the following features:
(1) A colored base coating composition comprising a chlorinated polyolefin resin grafted with an acrylic component (A1) in which the acrylic component has a glass transition temperature (Tg) of 60° C. or more, and an OH group (hydroxyl group)-containing acrylic resin (A2). The chlorinated polyolefin resin grafted with the acrylic component and the OH group-containing acrylic resin have a mass ratio (A1/A2) of nonvolatile matters thereof ranging from 70/30 to 50/50. The colored base coating composition is of a type that is formed into a film by drying.

The colored base coating composition of this invention may further comprise 3 to 14% by mass of a nonvolatile matter of a chlorinated polyolefin resin (B1), based on the total mass (A1+A2+B1) of the nonvolatile matters of the chlorinated polyolefin resin grafted with the acrylic component (A1), the OH group-containing acrylic resin (A2), and the chlorinated polyolefin resin (B1).
(2) A clear coating composition applied on a colored base coat formed by applying the aforementioned colored base coating composition, the clear coating composition comprising an urethane acrylate resin (C) having 2.5 or more photopolymerizable functional groups in one molecule thereof and having a weight average molecular weight (Mw) of 1100 to 3000and a photopolymerizable monomer (D). The urethane acrylate resin and the photopolymerizable monomer have a mass ratio (C/D) of nonvolatile matters thereof ranging from 10/90 to 40/60. The clear coating composition is of a type that is cured into a film with an active energy ray.

The clear coating composition of this invention may further include an organic solvent having an evaporation rate of 60 or more in an amount of 25% by mass or less, based on the mass of the nonvolatile matters of the clear coating composition.
(3) A multilayer coat forming method for forming a multilayer of a colored base coat formed by applying the aforementioned colored base coating composition and a clear coat formed by applying the aforementioned clear coating composition on a substrate made of a nonpolar resin, the method comprising: applying the colored base coating composition on the substrate to form the colored base coat and drying the coat so that a nonvolatile matter of the coat becomes 70 to 100% by mass; applying the clear coating composition having a coating viscosity of 15 to 50 mPa·s, on the colored base coat to form the clear coat; and irradiating the clear coat with an active energy ray in an atmosphere having an oxygen content of 5% by mass or less to cure the clear coat.

In the multilayer coat forming method of this invention, the temperature of the clear coating composition during the coating is controlled preferably within the range of 20 to 65° C.
(4) A coated resin product comprising a substrate made of a nonpolar resin, a colored base coat formed by applying the aforementioned colored base coating composition on the substrate and by drying the resultant coat to form the coat as a film, and a clear coat formed by applying the aforementioned clear coating composition on the colored base coat and by irradiating the resultant coat with an active energy ray to form the coat as a film.

The nonpolar resin of the coated resin product of this invention is preferably a polyolefin resin.

The colored base coating composition according to the present invention can be applied on a substrate made of a nonpolar resin, such as a polyolefin resin, even without applying a primer on the substrate. In addition, by coating the thus obtained coat with an active energy ray-curable clear coating composition, a satisfactory coat surface can be obtained.

The clear coating composition according to the present invention can be cured by irradiation with an active energy ray. When the clear coating composition is applied on a coat of the colored base coating composition, the surface of the coat of the colored base coating composition is satisfactory.

According to the multilayer coat forming method according to the present invention, a satisfactory multilayer coat on a substrate made of a nonpolar resin, such as a polyolefin resin, can be obtained.

According to the coated resin product of the present invention, a satisfactory shortening of the time for a coating process can be achieved.

### BRIEF DESCRIPTION OF THE DRAWING

FIG. 1 is a schematic view showing a bending test.

### DETAILED DESCRIPTION OF THE INVENTION

Hereinafter, a coating composition, a multilayer coat forming method using the coating composition, and a coated resin product formed by applying the coating composition according to embodiments of the present invention will be described specifically, and the description should not be construed as limiting the scope of the present invention. Further, the following examples can be appropriately modified and embodied so long as they do not depart from the gist and scope of the present invention.

### <Colored Base Coating Composition>

A colored base coating composition of the invention includes a chlorinated polyolefin resin grafted with an acrylic component (A1) in which the acrylic component has a glass transition temperature (Tg) of 60° C. or more; and an OH group (hydroxyl group)-containing acrylic resin (A2), wherein the chlorinated polyolefin resin grafted with the acrylic component and the OH group-containing acrylic resin have a mass ratio (A1/A2) of nonvolatile matters (NV) thereof ranging from 70/30 to 50/50. The colored base coating composition is of a type that is formed into a film by drying.

Further, the colored base coating composition according to the present invention may include 3 to 14% by mass of a nonvolatile matter of a chlorinated polyolefin resin (B1), based on the total mass (A1+A2+B1) of the nonvolatile matters of the chlorinated polyolefin resin grafted with the acrylic component (A1), the OH group-containing acrylic resin (A2), and the chlorinated polyolefin resin (B1).

The chlorinated polyolefin resin grafted with the acrylic component (A1) and the OH group-containing acrylic resin (A2) included in the colored base coating composition preferably have a mass ratio (A1/A2) of their nonvolatile matters ranging from 70/30 to 50/50. When the mass ratio (A1/A2) is more than 70/30 (i.e., the ratio of A2 becomes smaller), the interlayer adhesion between the colored base coat and the clear coat might be lowered. On the other hand, when the mass ratio is less than 50/50 (i.e., the ratio of A1 becomes smaller), the adhesion between the colored base coat and the substrate might be lowered and the appearance (distinctness) of a finished coat might be impaired. The mass ratio more preferably ranges from 65/35 to 55/45.

An acrylic moiety which is a side chain of the chlorinated polyolefin resin grafted with the acrylic component (A1) has Tg of 60° C. or more. When Tg of the acrylic moiety is less than 60° C., the colored base coat is eroded by a photopolymerizable monomer contained in the clear coating composition while being applied, whereby the appearance (distinctness) of a finished coat might be impaired.

The OH group-containing acrylic resin (A2) has an OH value of preferably 15 to 50 mgKOH/g, more preferably 20 to 45 mgKOH/g. When the OH value is less than 15 mgKOH/g, the interlayer adhesion between the colored base coat and the clear coat tends to be lowered. On the other hand, when the OH value is more than 50 mgKOH/g, the coat appearance tends to be problematically changed.

The OH group-containing acrylic resin (A2) includes a metha type thereof and is not particularly limited so long as it satisfies the above-noted conditions. It is composed of a (co)polymer obtained by (co)polymerizing a monomer component composed of a generally used (meth)acrylic monomer and if necessary, another ethylenically-unsaturated monomer, by a known method.

Examples of the (meth)acrylic monomer include a (meth)acrylic acid and esters thereof (for example, methyl ester, ethyl ester, propyl ester, n-butyl ester, i-butyl ester, t-butyl ester, 2-ethylhexyl ester, lauryl ester, phenyl ester, benzyl ester, isobornyl ester, 2-hydroxyethyl ester, 2-hydroxypropyl ester, 2-hydroxybutyl ester, 4-hydroxybutyl ester, (β-methyl) glycidyl ester and a monoester with a polyhydric alcohol, such as a polyethylene glycol); an acrylic monomer containing an amide group, such as (meth)acryl amide, N,N-dimethyl (meth)acryl amide and N,N-dibutyl (meth)acryl amide; and a 2-hydroxyethyl (meth)acrylate ring opening adduct of caprolactone.

Examples of the other ethylenically-unsaturated monomer include styrene, α-methylstyrene, N-vinylpyrrolidone, itaconic acid, maleic acid and vinyl acetate.

The colored base coating composition includes preferably 3 to 14% by mass of a nonvolatile matter of a chlorinated polyolefin resin (B1), based on the total mass (A1+A2+B1) of nonvolatile matters of a chlorinated polyolefin resin grafted with an acrylic component (A1) and an OH group-containing acrylic resin (A2) and a chlorinated polyolefin resin (B1). When the content of a nonvolatile matter of a chlorinated polyolefin resin (B1) in the total mass (A1+A2+B1) of nonvolatile matters of the resin is less than 3%, adhesion of the colored base coat with the substrate and coat distinctness of the coat tend to be lowered. When the content is more than 14% by mass, interlayer adhesion of the colored base coat with the clear coat tends to be lowered.

The chlorinated polyolefin resin (B1) is not particularly limited and examples thereof include a chlorinated polyethylene resin and a chlorinated polypropylene resin. Examples of commercially available products thereof include Superchlon 822 (trade name; manufactured by Nippon Paper Chemicals Industries Co., Ltd.), Hardlen EH202 (trade name; manufactured by Toyo Kasei Kogyo Co., Ltd.), Hardlen M128P (trade name; manufactured by Toyo Kasei Kogyo Co., Ltd.) and Hardlen 14ML (trade name; manufactured by Toyo Kasei Kogyo Co., Ltd.).

The colored base coating composition may, if necessary include the other resins than the above three resins (A1), (A2) and (B1), such as another acrylic resin than the OH group-containing acrylic resin (A2), a polyester resin, an epoxy resin and a polyurethane resin.

The colored base coating composition includes a colored pigment and/or a shining material as a colorant for causing the coating to exhibit beauty and hiding power properties. Examples of the colored pigment include, but not limited to an organic pigment, such as an azo lake pigment, an insoluble azo pigment, a condensed azo pigment, a phthalocyanine pigment, an indigo pigment, a perinone pigment, a perylene pigment, a phthalon pigment, a dioxazine pigment, a quinacridone pigment, an isoindolinone pigment, a benzimidazolone pigment, a diketo-pyrrolo-pyrrole pigment and a metal complex pigment; and an inorganic pigment, such as yellow iron oxide, red oxide, carbon black and titanium dioxide. Examples of the shining material include, but not limited to mica pigments, such as a white mica, a colored mica and a interference mica; and flake-shaped pigments, such as an aluminum flake pigment, a metal oxide coated alumina flake pigment, a metal oxide coated silica flake pigment, a graphite pigment, a metal titanium flake pigment, a stainless flake pigment, a plate-shaped iron oxide pigment, a metal plated glass flake pigment, a metal oxide coat-plated glass flake pigment, a hologram pigment and a flake-shaped pigment composed of a cholesteric liquid crystal polymer. The colored base coating composition includes at least one pigment selected from the group consisting of these colored pigments and shining materials. The colored base coating composition, if necessary may include an extender pigment. Examples of the extender pigment include talc, calcium carbonate, precipitated barium sulfate and silica.

In the colored base coating composition, if necessary a leveling agent, an ultra violet ray absorbent, an antioxidant, an anti-yellowing agent, an antifoaming agent, a thickening agent, an antistatic agent or an anti-settling agent may be appropriately incorporated so long as the advantage of the present invention is not impaired.

### <Clear Coating Composition>

A clear coating composition of the invention is a clear coating composition which is applied on a colored base coat formed by applying the aforementioned colored base coating composition, and includes an urethane acrylate resin (C) having 2.5 or more photopolymerizable functional groups in one molecule thereof and having a weight average molecular weight (Mw) of 1100 to 3000 and a photopolymerizable monomer (D), wherein the urethane acrylate resin and the photopolymerizable monomer have a mass ratio (C/D) of nonvolatile matters thereof ranging from 10/90 to 40/60. The clear coating composition is of a type that is cured into a film with an active energy ray.

Further, the clear coating composition according to the invention may include an organic solvent having an evaporation rate of 60 or more in an amount of 25% by mass or less, based on the mass of the nonvolatile matters of the clear coating composition.

The formulation ratio of the urethane acrylate resin (C) and the photopolymerizable monomer (D) which are included in the clear coating composition is a mass ratio (C/D) of nonvolatile matters thereof of necessary 10/90 to 40/60 for securing curability of the clear coating composition itself, chemical resistance, strength of the film, thickness sense, and weathering resistance of the clear coat, of preferably 15/85 to 35/65.

The urethane acrylate resin (C) is necessary to have 2.5 or more photopolymerizable functional groups in one molecule thereof for securing curability of itself and the adhesion between the clear coat and the colored base coat, and has preferably 3 or more photopolymerizable functional groups. Further, the urethane acrylate resin (C) is necessary to have a weight average molecular weight (Mw) of 1100 to 3000 for securing a suitable coating viscosity and strength of the film, and has preferably an Mw of 1500 to 2500.

Further, the urethane acrylate resin (C) includes a metha type thereof and is not particularly limited so long as it satisfies the above conditions. Examples thereof include i) a compound obtained by reacting a compound having two or more isocyanate groups in a molecule thereof with a compound having one or more hydroxyl group and one or more double-bond group in a molecule thereof in equivalent amounts, ii) a compound obtained by reacting a compound having one or more hydroxyl group and one or more double-bond group in a molecule thereof with a reaction product of a reaction between a condensation product of a polyhydric alcohol with a monobasic acid and/or a polybasic acid and/or an acid anhydride thereof, and a compound having two or more isocyanate groups in a molecule thereof, and iii) a compound obtained by reacting a compound having one or more hydroxyl group and one or more double-bond group in a molecule thereof with a reaction product of a reaction between a polyhydric alcohol and a compound having two or more isocyanate groups in a molecule thereof. In the above i) to iii), the compound having two or more isocyanate groups in a molecule thereof is desirably another compound than an aromatic isocyanate compound. Further, in the above i) to iii), examples of the compound having one or more hydroxyl group and one or more double-bond group in a molecule thereof include 2-hydroxy (meth)acrylate, 2-hydroxypropyl (meth)acrylate, 4-hydroxybutyl (meth)acrylate, pentaerythritol triacrylate, dipentaerythritol pentaacrylate and a commercial available product Placcel F(M)A Series (trade name; manufactured by Daicel Chemical Industries, Ltd.). Further, in the above ii) to iii), examples of the polyhydric alcohol include polyethylene glycol, polycarbonate diol, polytetramethylene glycol, trimethylol propane and commercially available products, such as Placcel diol series and Placcel triol series (trade names; manufactured by Daicel Chemical Industries, Ltd.).

The clear coating composition may include, if necessary another resin than the urethane acrylate resin (C), such as a photocurable resin, for example an acrylic main chain-based, polyester main chain-based, epoxy main chain-based or polyether main chain-based polyacrylate resin.

The photopolymerizable monomer (D) used as a reactive diluent is not particularly limited and examples thereof include the monomers described in the above section of the colored base coating composition, as follows. A (meth)acrylic acid and esters thereof (for example, methyl ester, ethyl ester, propyl ester, n-butyl ester, i-butyl ester, t-butyl ester, 2-ethylhexyl ester, lauryl ester, phenyl ester, benzyl ester, isobornyl ester, 2-hydroxyethyl ester, 2-hydroxypropyl ester, 2-hydroxybutyl ester, 4-hydroxybutyl ester, (β-methyl)glycidyl ester and a monoester with a polyhydric alcohol, such as a polyethylene glycol); an acrylic monomer containing an amide group, such as (meth)acryl amide, N,N-dimethyl (meth)acrylamide and N,N-dibutyl (meth)acryl amide; and a 2-hydroxyethyl (meth)acrylate ring opening adduct of caprolactone.

Examples of the other ethylenically unsaturated monomer include styrene, α-methylstyrene, N-vinylpyrrolidone, itaconic acid, maleic acid and vinyl acetate, as well as a mono-ordi (meth)acrylate of a diol, such as 1,6-hexane diol, 1,9-nonane diol and diethylene glycol; a di- or tri(meth)acrylate of a triol, such as glycerin, trimethylol ethane and trimethylol propane; tri- or tetra (meth)acrylate of pentaerythritol; and tetra-, penta- or hexa (meth)acrylate of dipentaerythritol.

The clear coating composition contains a photopolymerization initiator for securing photopolymerizability. The content of the photopolymerization initiator is preferably 1 to 15% by mass, based on the mass of the resin portion (including a photopolymerizable monomer) in the clear coating composition. When the content is less than 1% by mass, the curing by an active energy ray becomes unsatisfactory, so that weathering resistance and adhesion to the substrate might be lowered. On the other hand, when the content is more than 15% by mass, excessive photopolymerization initiator remains, which might be a cause of the lowering of weathering resistance and the discoloration of the coat. The type of the photopolymerization initiator is not particularly limited and generally used photopolymerization initiators can be used also in the present invention. Specific examples thereof include benzoin-based compounds, such as benzoin, benzoin methyl ether, benzoin isopropyl ether and benzoin isobutyl ether;

benzophenone-based compounds, such as benzophenone, benzophenone methyl ether, methyl benzophenone and 2,4,6-trimethyl benzophenone; anthraquinone-based compounds, such as 2-ethyl anthraquinone and 2-t-butyl anthraquinone; ketone-based compounds, such as 2,2-dimethoxy-2-phenylacetophenone, 2,2-diethoxy acetophenone, p-dimethyl aminoacetophenone, hydroxycyclohexyl phenyl ketone, 2-hydroxy-2-methyl-1[4-(1-methylvinyl)phenyl] propane, 1-[4-(4-benzoylphenylsulfanil) phenyl]-2-methyl-2(4-methylphenylsulfa) propane-1-one.

phosphine-based compounds, such as 2,4,6-trimethylbenzoyldiphenylphosphine oxide, bis(2,4,6-trimethylbenzoyl)-phenylphosphine oxide and bis(2,6-dimethoxybenzoyl)-2,4,4-trimethylphenylphosphine oxide; and

other compounds, such as methyl phenylglyoxylate ester, 2,4-dimethyl thioxanthone, 2,4-diisopropyl thioxanthone, 2,4-diethyl thioxanthone and 2-isopropyl thioxanthone.

Further, in the case of a curing in the presence of a UV absorbent, it is preferred that as a photopolymerization initiator, a photopolymerization initiator having the maximum absorbance wavelength in a wavelength range of 350 nm or more, such as 2,4,6-trimethylbenzoyldiphenylphosphine oxide is used in combination with a hydrogen-abstraction photopolymerization initiator, such as benzophenone.

The clear coating composition includes a UV absorbent for imparting curability by an active energy. The content of the UV absorbent is preferably 0.1 to 10% by mass, more preferably 0.5 to 5% by mass, based on the mass of the resin portion in the clear coating composition. When the content is less than 0.1% by mass, weathering resistance might become unsatisfactory. On the other hand when the content is more than 10% by mass, the curing by an active energy is extremely inhibited and weathering resistance and adhesion to the substrate might be lowered. The type of the UV absorbent is not particularly limited and generally used UV absorbents can be used also in the present invention. Specific examples thereof include triazine-based compounds, such as 2-[4-[(2-hydroxy-3-dodecyloxypropyl)oxy]-2-hydroxyphenyl]-4,6-bis(2,4-dimethylphenyl)-1,3,5-triazine, 2-[4-[(2-hydroxy-3-tridecyloxypropyl)oxy]-2-hydroxyphenyl]-4,6-bis(2,4-dimethylphenyl)-1,3,5-triazine and 2,4-bis(2,4-dimethylphenyl)-6-(2-hydroxy-4-isooctyloxyphenyl)-S-triazine;

triazole-based compounds, such as 2-(2′-hydroxy-5′-methylphenyl)benzotriazole, 2-[2′-hydroxy-3′,5′-bis(α,α-dimethylbenzyl)phenyl]benzotriazole, 2-(2′-hydroxy-3′,5′-di-t-butylphenyl)benzotriazole, 2-(2′-hydroxy-3′,5′-di-t-amyl)benzotriazole, 2-(2′-hydroxy-5′-t-octylphenyl)benzotriazole and 2-(2′-hydroxy-5′-methacryloxyethylphenyl)-2H-benzotriazole; benzophenone-based compounds, such as 2,4-dihydroxybenzophenone, 2-hydroxy-4-methoxybenzophenone, 2-hydroxy-4-n-octoxybenzophenone and 2-hydroxy-4-n-dodecyloxybenzophenone; and salicylate-based compounds, such as phenylsalicylate, 4-t-butylphenylsalicylate and 4-t-octylphenylsalicylate.

The clear coating composition may include a light stabilizer for securing the light stability. The content of the light stabilizer is preferably 0.1 to 10% by mass, more preferably 0.5 to 5% by mass, based on the mass of the resin portion in the clear coating composition. The type of the light stabilizer is not particularly limited and generally used light stabilizers can be used also in the present invention. Specific examples thereof include hindered amine compounds, such as bis(N-methyl-2,2,6,6-tetramethyl-4-piperidinyl)sebacate, bis(2,2,6,6-tetramethyl-4-piperidinyl)sebacate, methyl(1,2,2,6,6-pentamethyl-4-piperidinyl)sebacate, bis(N-octyloxy-2,2,6,6-tetramethyl-4-piperidinyl)sebacate, and 1,2,2,6,6-pentamethyl-4-piperidyl methacrylate; and cyanoacrylate-based compounds, such as ethyl-2-cyano-3,3-diphenylacrylate, and 2-ethylhexyl-2-cyano-3,3′-diphenylacrylate.

The clear coating composition may also include, if necessary an organic solvent besides the photopolymerizable monomer (D) for securing the spray suitability. In this case, taking into consideration the recover and recycle of the clear coating composition, it is preferred that the amount of the organic solvent used is small. Further, for saving the time for the clear coat formation, an organic solvent having a large evaporation rate is desired. More specifically, it is preferred that an organic solvent having a relative evaporation rate of 60 or more as assumed that the evaporation rate (in mass) of n-butyl acetate ester is 100, is used in an amount of 25% by mass, based on the mass of the nonvolatile matter of the clear coating composition. Examples of such organic solvents include methyl alcohol (370), isopropyl alcohol (205), ethyl alcohol (203), n-propyl alcohol (130), 2-butyl alcohol (115), i-butyl alcohol (83), propylene glycol monomethyl ether (66), n-hexane (1000), cyclohexane (720), toluene (195), ethylcyclohexane (145), xylene (68), acetone (720), methyl ethyl ketone (465), methyl isobutyl ketone (160), ethyl acetate ester (525), isopropyl acetate ester (435), 2-butyl acetate ester (180), n-butyl acetate ester (100) and 2-amyl acetate ester (87), where the numbers in the round parentheses indicate an evaporation rate.

The clear coating composition may appropriately include, if necessary also an anti-yellowing agent, an antifoaming agent, a thickening agent, an antistatic agent, an antifogging agent, an leveling agent, a color pigment, an extender pigment or a dye.

### <Substrate>

The substrate is made of a nonpolar resin containing no hetero atom in the molecule thereof. The nonpolar resin is not particularly limited and examples thereof include polyolefin resins, such as a polyethylene resin and a polypropylene resin; and polystyrene resins. The nonpolar resin is preferably polyolefin resins to which the colored base coating composition is advantageously adhered.

### <Multilayer Coat Forming Method>

A multilayer coat forming method of the invention is a method for forming a multilayer of a colored base coat formed by applying the aforementioned colored base coating composition and a clear coat formed by applying the aforementioned clear coating composition on a substrate made of a nonpolar resin, and the method includes: applying the colored base coating composition on the substrate to form the colored base coat and drying the coat so that a nonvolatile matter of the coat becomes 70 to 100% by mass; applying the clear coating composition having a coating viscosity of 15 to 50 mPa·s, on the colored base coat to form the clear coat; and irradiating the clear coat with an active energy ray in an atmosphere having an oxygen content of 5% by mass or less to cure the clear coat.

Further, in the multilayer coat forming method according to the invention, the temperature of the clear coating composition during the coating is controlled preferably within the range of 20 to 65° C.

By the multilayer coat forming method of the present invention, not only the appearance (distinctness) can be prevented from being impaired and solvent resistance, adhesion, hardness, strength of the film, weathering resistance and chemical resistance can be enhanced, but also the time for the coating process can be shortened and if necessary, the clear coating composition can be recovered, so that the waste of the coating can be prevented.

The method for coating the colored base coating composition and the clear coating composition is not particularly limited and examples thereof include known coating methods, such as an air spraying coating, an airless spraying coating, an immersing coating, a shower coat coating, a roll coater coating and a rotary bell coating. In the case of the spraying coating and the rotary bell coating, the coating may be an electrostatic coating.

Further, the coating of the colored base coating composition or the clear coating composition may be performed not only in a single time, but also in a plurality of times. In the case of the coating in a plurality of times, each coating may be performed by the same coating method or by different coating methods, or may be performed with the same coating or with different coating compositions. By applying in a plurality of times, the colored base coat or the clear coat can be caused to be a multilayer.

To perform the coating with the clear coating composition at the time when a nonvolatile matter in the colored base coat has become 70 to 100% by mass is necessary for securing the interface controlling properties between the colored base coat and the clear coat (for preventing the impairment of the distinctness) and for preventing the cohesive failure of the colored base coat or the intercoat adhesive failure between the clear coat and the colored base coat, and it is more preferred to perform the coating with the clear coating composition at the time when a nonvolatile matter in the colored base coat has become 80 to 100% by mass. Further, when the colored base coat is caused to be a multilayer by performing the colored base coating composition in a plurality of times, the coating with the clear coating composition is performed at the time when a nonvolatile matter in the outermost layer of the colored base coat has become the above-noted range.

The conditions for causing the nonvolatile matter in the colored base coat to be 70 to 100% by mass can be preset according to a preliminary test with respect to the design of a spray thinner used for a coating, the conditions of a drying booth in a coating factory (for example, the temperature of a heated air for drying, the wind velocity of a heated air and the line speed) and the like.

To perform the coating with the clear coating composition so that a coating viscosity of the clear coating composition becomes 15 to 50 mPa·s (in this case, if necessary the coating in which the coating viscosity becomes more than 50 mPa·s is performed at an elevated temperature of 65° C. or less) is necessary for while securing the interface controlling properties between the colored base coat and the clear coat (for preventing the impairment of the distinctness), preventing the sagging of the clear coating composition and it is more preferred that the coating is performed so that the coating viscosity becomes 20 to 40 mPa·s.

The most simple and easy method for controlling the coating viscosity of the clear coating composition within the above appropriate range is to control the coating viscosity by the amount of the photopolymerizable monomer, taking into consideration the above-noted recover and recycle of the clear coating composition. However, for securing the curability of the clear coating composition and the physical properties of the clear coat, the amount of the photopolymerizable monomer has an upper limit. Therefore, it is effective to attempt the adequacy of the coating viscosity either only by warming the clear coating composition or by a combination of suppressing the amount of the photopolymerizable monomer at a necessary minimum amount and warming the clear coating composition.

At this time, taking into consideration the thermal stability and workability of the clear coating composition, the clear coating composition is performed at a coating temperature of preferably 20 to 65° C., more preferably 35 to 60° C.

To perform the curing by irradiation with an active energy ray in an atmosphere having an oxygen content of 5% by mass or less is necessary for securing the appearance quality, that is, the interface controlling properties between the colored base coat and the clear coat (for preventing the impairment of the distinctness), the homogeneity of the curing, the strength of the film, the adhesion between the coat and the substrate, and the weathering resistance and chemical resistance, and it is more preferred to perform the curing in an atmosphere having an oxygen content of 2% by mass or less.

The method for irradiating an active energy ray is not particularly limited and may be an usual method. Example thereof include a method for irradiating a UV ray using as a light source, a high-pressure mercury vapor lamp, a metal halide lamp or the like. In the present invention, the active energy ray is not limited to a UV ray and may be also, for example a visible light or an electron beam. In the case of irradiating a UV ray as an active energy ray, an integrated light amount is preferably 500 to 5000 mJ/cm², more preferably 1500 to 4000 mJ/cm².

The coat thickness of the colored base coat (after cured) is not particularly limited and is preferably 8 to 30 μm, more preferably 10 to 20 μm.

The coat thickness of the clear coat (after cured) is not particularly limited and is preferably 10 to 50 μm, more preferably 20 to 40 μm. When the coat thickness of the clear coat is less than 10 μm, the distinctness and the interlayer adhesion between the clear coat and the colored base coat might become unsatisfactory. On the other hand, when the coat thickness is more than 50 μm, the active energy ray is unlikely to reach a side of the clear coat in the near of the interface between the colored base coat and the clear coat and consequently, the crosslinking density of a portion of the clear coat in the near of the interface is lowered, so that the weathering resistance might be lowered and the cohesive failure of the colored base coat might be caused.

According to the multilayer coat forming method of the present invention, in a short time, a multilayer coat which not only has a high appearance quality (distinctness), but also is excellent in various qualities required for an exterior part, such as solvent resistance, adhesion, hardness, strength of the film, weathering resistance and chemical resistance, can be obtained.

The multilayer coat forming method of the present invention may be performed, for example as follows. On a substrate degreased by cleaning, the colored base coat is coated so that the thickness of the dried colored base coat becomes 8 to 30 μm. Then, the colored base coat is forced to be dried at a high temperature (for example, 80° C.) and is cooled to 50° C. or less. Next, the clear coating composition of which temperature during the coating is controlled within the range of 20 to 65° C. so that the coating viscosity of the clear coating composition becomes 15 to 50 mPa·s, is coated so that the coat thickness after cured becomes 10 to 50 μm. Next, using a high-pressure mercury vapor lamp or a metal halide lamp, in an atmosphere having an oxygen content of 5% by mass or less, a UV ray having a UV ray light amount of 500 to 5000 mj/cm² is irradiated to the coat to cure the coated coat, to thereby form a multilayer coat composed of the colored base coat and the clear coat.

### EXAMPLES

The present invention will be described more specifically referring to examples that should not be construed as limiting the scope of the present invention. Hereinafter, unless otherwise specified, “parts by mass” is indicated only as “parts” and “% by mass” is indicated only as “%”.

As resins constituting the colored base coating composition and the clear coating composition which have been used in the following examples and comparative examples, the resins shown in Tables 1 to 3 were used.

TABLE 1

| | | A1-1 | | A1-2 | | A1-3 | |
|---|---|---|---|---|---|---|---|
| | | Nonvolatile | | Nonvolatile | | Nonvolatile | |
| chlorinated polyolefin resin grafted | | matter | Sample | matter | Sample | matter | Sample |
| with acrylic component (A1) | | Amount | Amount | Amount | Amount | Amount | Amount |
| Precharge | Superchlon 822 | 20 | 100 | 20 | 100 | 20 | 100 |
| Monomer | methyl methacrylate | 67.2 | 67.2 | 40 | 40 | 16 | 16 |
| mixture | methacrylic acid | 0.8 | 0.8 | 0.8 | 0.8 | 0.8 | 0.8 |
| | n-butyl methacrylate | 12 | 12 | 12 | 12 | 20 | 20 |
| | isobutyl methacrylate | 0 | 0 | 27.2 | 27.2 | 43.2 | 43.2 |
| Polymerization | propylene glycol monomethyl ether | 0 | 4 | 0 | 4 | 0 | 4 |
| initiator | toluene | 0 | 12 | 0 | 12 | 0 | 12 |
| solution | n-butyl acetate | 0 | 5 | 0 | 5 | 0 | 5 |
| | t-butyl-peroxy-2-ethylhexanoate | 2.2 | 2.2 | 2.2 | 2.2 | 2.2 | 2.2 |
| Post | propylene glycol monomethyl ether | 0 | 1 | 0 | 1 | 0 | 1 |
| polymerization | toluene | 0 | 2 | 0 | 2 | 0 | 2 |
| initiator | n-butyl acetate | 0 | 1 | 0 | 1 | 0 | 1 |
| solution | t-butyl-peroxy-2-ethylhexanoate | 0.3 | 0.3 | 0.3 | 0.3 | 0.3 | 0.3 |
| Post | propylene glycol monomethyl ether | 0 | 8 | 0 | 8 | 0 | 8 |
| dissolving | toluene | 0 | 17 | 0 | 17 | 0 | 17 |
| solvent | n-butyl acetate | 0 | 8 | 0 | 8 | 0 | 8 |

| | | | | | | |
|---|---|---|---|---|---|---|
| Total | 102.5 | 240.5 | 102.5 | 240.5 | 102.5 | 240.5 |

| | | | |
|---|---|---|---|
| Content of Nonvolatile matter | 42% | 42% | 42% |
| Tg of acrylic moiety | 95° C. | 70° C. | 50° C. |
| Mass ratio | 80/20 | 80/20 | 80/20 |
| acrylic moiety/acid anhydride-modified | | | |
| chlorinated polyolefin | | | |

Note)
Superchlon 822: acid anhydride-modified chlorinated polyolefin resin, tradename manufactured by Nippon Paper Chemicals Industries Co., Ltd.; the content of a nonvolatile matter is 20%, chlorinated degree is 25%

### Synthesis Examples of Chlorinated Polyolefin Resin Grafted with Acrylic Component

A chlorinated polyolefin resin grafted with an acrylic component A1-1 was synthesized according to the formulation shown in Table 1.

Specifically, into a reactor equipped with a stirrer, a thermometer, a refluxing pipe, a dropping funnel, a nitrogen introducing pipe and a heating/cooling apparatus with a thermostat, 100 parts of an acid anhydride-modified chlorinated polyolefin resin (trade name: Superchlon 822; manufactured by Nippon Paper Chemicals Industries Co., Ltd.; the content of a nonvolatile matter is 20%) were charged and while stirring the resultant mixture, the temperature inside the reactor was elevated to 110° C.

After the temperature of the inside solution reached 110° C., a monomer mixture composed of 67.2 parts of methyl methacrylate, 0.8 part of methacrylic acid and 12 parts of n-butyl methacrylate and a polymerization initiator solution composed of 4 parts of propylene glycol monomethyl ether, 12 parts of toluene, 5 parts of n-butyl acetate and 2.2 parts of t-butyl-peroxy-2-ethylhexanoate as a peroxide-based polymerization initiator, were individually charged into an individual dropping funnel and were individually dropped into the reactor over three hours while maintaining the temperature inside the reactor at 110° C. and stirring the content of the reactor.

Thereafter, further a post polymerization initiator solution composed of 1 part of propylene glycol monomethyl ether, 2 parts of toluene, 1 part of n-butyl acetate and 0.3 part of t-butyl-peroxy-2-ethylhexanoate was dropped into the reactor over two hours while maintaining the temperature inside the reactor at 110° C. and stirring the content of the reactor, to thereby complete a graft-polymerization reaction.

Then, after the temperature inside the reactor was lowered to 60° C., 8 parts of propylene glycol monomethyl ether, 17 parts of toluene and 8 parts of n-butyl acetate were injected into the reactor in this order and the resultant resin solution was cooled to room temperature, to thereby complete the synthesis.

As shown in Table 1, the content of the nonvolatile matter of the synthesized product was 42% and the Tg of a copolymer in the acrylic moiety thereof was 95° C., as measured by the below-described methods.

Further, the chlorinated polyolefin resins grafted with the acrylic component A1-2 and A1-3 were also synthesized according to the formulations shown in Table 1 by substantially the same method as that of A1-1. A1so, the content of the nonvolatile matter and the Tg of a copolymer in the acrylic moiety of these resins were measured.

### <Content of Nonvolatile Matter of Resin Solution>

The content of the nonvolatile matter (R) of a resin solution was measured according to JIS-K5601-1-2 and obtained from a residual amount of the nonvolatile matter (a) after heat-drying a resin solution at 105° C. for three hours and an amount of a resin solution before drying (b) and from the following equation. Note that “nonvolatile matter” is meant to include “solids content”.

$$R ( \% ) = \frac{a}{b} \times 100 \qquad < Equation 1 >$$

### <Tg of Acrylic Moiety>

For the measurement of the Tg (glass transition temperature) of a copolymer in the acrylic moiety which is side chains of a chlorinated polyolefin resin grafted with an acrylic component, a polymerization only of an acrylic monomer (not including an acid anhydride-modified chlorinated polyolefin) in the formulation shown in Table 1 was performed and from the resultant resin solution, a solid acrylic copolymer resin was obtained by distilling off a volatile solvent portion from the resin solution using reduced pressure, and the obtained solid acrylic copolymer resin was used as the sample.

The glass transition temperature of the above sample was measured using a differential scanning calorimeter (DSC) (trade name: Thermal Analysis Apparatus SSC/5200H; manufactured by Seiko Instruments Inc.) according to the following steps.
First step: the temperature of the sample; 20° C. [symbol] 100° C. (temperature elevating rate 10° C./min)
Second step: the temperature of the sample; 100° C. [symbol] −50° C. (temperature lowering rate 10° C./min)
Third step: the temperature of the sample; −50° C. [symbol] 100° C. (temperature elevating rate 10° C./min)
In the third step, the Tg was obtained during the temperature elevation.

TABLE 2

| | | A2-1 | | A2-2 | | A2-3 | |
|---|---|---|---|---|---|---|---|
| | | Nonvolatile | | Nonvolatile | | Nonvolatile | |
| | | matter | Sample | matter | Sample | matter | Sample |
| OH group-containing acrylic resin (A2) | | Amount | Amount | Amount | Amount | Amount | Amount |
| Precharge solvent | toluene | 0 | 40 | 0 | 40 | 0 | 40 |
| | n-butanol | 0 | 10 | 0 | 10 | 0 | 10 |
| Monomer mixture | methylmethacrylate | 18 | 18 | 17 | 17 | 21 | 21 |
| solution | ethylacrylate | 47 | 47 | 43 | 43 | 52 | 52 |
| | Placcel FM-1 | 15 | 15 | 20 | 20 | 9 | 9 |
| | N-vinylpyrolidone | 20 | 20 | 20 | 20 | 18 | 18 |
| | toluene | 0 | 18 | 0 | 18 | 0 | 18 |
| Polymerization | xylol | 0 | 2 | 0 | 2 | 0 | 2 |
| initiator solution | t-butyl-peroxy-2-ethylhexanoate | 0.7 | 0.7 | 0.7 | 0.7 | 0.7 | 0.7 |
| Post polymerization | toluene | 0 | 2 | 0 | 2 | 0 | 2 |
| initiator solution | t-butyl-peroxy-2-ethylhexanoate | 0.3 | 0.3 | 0.3 | 0.3 | 0.3 | 0.3 |
| Post dissolving | toluene | 0 | 28 | 0 | 28 | 0 | 28 |
| solvent | | | | | | | |

| | | | | | | |
|---|---|---|---|---|---|---|
| Total | 101 | 201 | 101 | 201 | 101 | 201 |

| | | | |
|---|---|---|---|
| Content of Nonvolatile matter | 50% | 50% | 50% |
| OH value (mgKOH/g) | 35 | 45 | 20 |

Note)
Placcel FM-1: tradename manufactured by Daicel Chemical Industries, Ltd.

### Synthesis Example of OH Group-Containing Acrylic Resin

An OH group-containing acrylic resin A2-1 was synthesized according to the formulation shown in Table 2.

Specifically, into an usual acrylic resin reaction vessel equipped with a stirrer, a thermometer and a refluxing-cooling apparatus, 40 parts of toluene and 10 parts of n-butanol were charged and while stirring the resultant mixture, the temperature inside the reaction vessel was elevated to 105° C.

After the temperature of the inside solution reached 105° C., a monomer mixture solution composed of 18 parts of methylmethacrylate, 47 parts of ethylacrylate, 15 parts of Placcel FM-1 (trade name; manufactured by Daicel Chemical Industries, Ltd.), 20 parts of N-vinylpyrolidone and 18 parts of toluene, and a polymerization initiator solution composed of 2 parts of xylol and 0.7 part of t-butyl-peroxy-2-ethylhexanoate were dropped in parallel into the reaction vessel over three hours while maintaining the temperature of inside the reaction vessel at 105° C. and stirring the content of the reaction vessel.

Further, after maintaining the temperature at 105° C. for 30 minutes, a post polymerization initiator solution composed of 2 parts of toluene and 0.3 part of t-butyl-peroxy-2-ethylhexanoate was dropped into the reaction vessel over 30 minutes. Thereafter, the content of the reaction vessel was continuously stirred for 2 hours while maintaining the reaction temperature at 105° C. and was cooled, followed by adding 28 parts of toluene to the resultant content of the reaction vessel to dilute it.

As shown in Table 2, the content of the nonvolatile matter of the synthesized product was 50% and the OH value was 35 mgKOH/g as measured by the below-described method.

Further, OH group-containing acrylic resins A2-2 and A2-3 were synthesized according to the formulation shown in Table 2 by substantially the same method as that of A2-1. Also, the content of the nonvolatile matter and the OH value of these resins were measured.

### <OH Value>

For measuring the OH value of an OH group-containing acrylic resin solution, a burette, a whole pipette, a conical flask with an air condenser and a thermostat bath capable of being set at 98±2° C. were prepared.

Further, as measuring reagents, a phthalic anhydride pyridine solution prepared by dissolving completely 42 g of phthalic anhydride in 300 mL of pyridine and by ageing at 70° C. for 2 hours and preserved in a brown bottle, pyridine, a ½N sodium hydroxide solution and a phenolphthalein pyridine solution were prepared.

The measurement was performed as follows.

First, 10 g of a resin solution sample were taken into the conical flask exactly to 1 mg and thereto, 25 mL of a phthalic anhydride pyridine solution were exactly added using a whole pipette. Thereafter, the flask was placed in a thermostat bath of 90±2° C. and the flask was heated for 2 hours while stirring slowly the flask at intervals.

Thereafter, the flask was cooled to room temperature and the air condenser was detached to be washed with pyridine. The resultant wash liquid was poured into the flask and into the flask, 50 mL of a ½N sodium hydroxide solution was exactly added.

Next, 10 drops of a phenolphthalein pyridine solution as an indicator were added into the flask and the titration was performed using a ½N sodium hydroxide solution. The end point of the titration was determined as the point when the solution to be titrated has maintained a red color thereof for 15 seconds.

Also, a blank test without using the resin solution was performed in substantially the same condition as that in the sample titration.

From the above test result, the OH value (mgKOH/g) was obtained by calculating using the following equation.

$$\text{OH} \text{VALUE} = 28.05 \times \frac{B - A}{S} \times f \\ \text{where} , \\ {}_{ }^{``}{A}{}_{ }^{″} represents an amount ( mL ) of a 1 / 2 N sodium hydroxide solution required for the titration of the sample , \\ {}_{ }^{``}{B}{}_{ }^{″} represents an amount ( mL ) of a 1 / 2 N sodium hydroxide solution required for the titration of the blank test , \\ {}_{ }^{``}{f}{}_{ }^{″} represents the factor of a 1 / 2 N sodium hydroxide solution , and \\ {}_{ }^{``}{S}{}_{ }^{″} represents the amount of the sample ( g ) . \qquad < Equation 2 >$$

TABLE 3

| Components of clear | | |
|---|---|---|
| coating composition | Trade name/Manufacturer name | Characteristic |
| urethane acrylate | LR8987-100/BASF Japan Ltd. | Weight average molecular weight: 1900 |
| resin (C) | | Number of photopolymerizable functional groups: 3 |
| | TO-2284/Toagosei Co., Ltd. | Weight average molecular weight: 1200 |
| | | Number of photopolymerizable functional groups: 2 |
| | UA-1/Self synthesized product | Weight average molecular weight: 980 |
| | | Number of photopolymerizable functional groups: 3 |
| | H-7/Negami Chemical Industrial Co., | Weight average molecular weight: 10000 |
| | Ltd. | Number of photopolymerizable functional groups: 3 |
| Photopolymerizable | 1,9-nonane diol diacrylate | |
| monomer (D) | | |
| cellulose acetate | CAB551-0.01/Eastman Chemical Japan | Tg: 85° C. |
| butylate resin | Co., Ltd. | Number average molecular weight: 16000 |
| (CAB resin) (B2) | CAB551-0.2/Eastman Chemical Japan | Tg: 101° C. |
| | Co., Ltd. | Number average molecular weight: 30000 |
| Photopolymerization | DAROCUR MBF/Ciba Specialty Chemicals | |
| initiator | LUCIRIN TPO/BASF Japan Ltd. | |
| UV absorbent | TINUVIN 400/Ciba Specialty Chemicals | |
| Light stabilizer | TINUVIN 292/Ciba Specialty Chemicals | |
| Surface controller | BYK333/Byk Chemie Japan Co., Ltd. | |

### Synthesis Example of Urethaneacrylate Resin UA-1

Into a flask equipped with a stirring blade, a thermometer, a temperature regulator and a cooling pipe, 498 parts of ethyl acetate ester, 240 parts (2 mol) of trimethylol ethane and 2 parts of dibutyltin dilaurate were charged and the temperature of the resultant mixture was elevated to 60° C. Next, 1008 parts (6 mol) of hexamethylene diisocyanate was dropped into the flask over 60 minutes while maintaining the temperature inside the flask at 60° C. and further for 60 minutes, the temperature inside the flask was maintained at 60° C. While blowing air into the flask, 730.8 parts (6.3 mol) of 2-hydroxyacrylate and 2 parts of hydroquinone were dropped into the flask over 60 minutes and further for 60 minutes, the temperature inside the flask was maintained at 60° C. After it was confirmed that there was no residual isocyanate group, at the temperature of 50° C. under reduced pressure, by removing ethyl acetate ester, an urethaneacrylate resin UA-1 having a nonvolatile matter content of 99%, a weight average molecular weight of 980 and the number of photopolymerizable functional groups of 3 was obtained.

Using the resins shown in Tables 1 and 2, according to the formulations shown in Tables 4 to 7, by the following preparing method, the colored base coating compositions b-1 to b-13, s-1, w-1 and p-1 were prepared, as well as using the compositions shown in Table 3, according to the formulations shown in Tables 9 and 10, the clear coating compositions UV-1 to UV-9 were prepared.

### Preparation Example of Colored Base Coating Composition

Into a container with a stirrer, a chlorinated polypropylene resin grafted with an acrylic component (A1), an OH group-containing acrylic resin (A2), toluene, and, if necessary isopropyl alcohol and a chlorinated polypropylene resin (B1) were charged and while stirring the resultant mixture, any one pigment of a black pigment paste, an aluminum pigment, a white pigment paste and a mica pigment and toluene were added to the mixture in this order. Then, the mixture was stirred for 30 minutes to obtain a colored base coating composition. The pigment paste was prepared by premixing the raw materials according to the formulations shown in Tables 11 and 12 and by dispersing the resultant mixture for 30 minutes using a sand grinder mill.

### Preparation Example of Clear Coating Composition

Into a container with a stirrer, a photopolymerizable monomer (D) was charged and while stirring the monomer, a cellulose acetate butylate resin was gradually added thereto, followed by allowing the resultant mixture to stand for 30 minutes. Thereafter, while stirring the mixture, thereto were added a photopolymerization initiator, a UV ray absorbent, a light stabilizer, a surface controller, an urethane acrylate (C) and, if necessary butyl acetate ester, and the resultant mixture was allowed to stand for 30 minutes, to thereby obtain the clear coating composition.

TABLE 4

| | NV % | b-1 | | b-2 | | b-3 | | b-4 | | b-5 | |
|---|---|---|---|---|---|---|---|---|---|---|---|
| | Content of | Non- | | Non- | | Non- | | Non- | | Non- | |
| | non- | volatile | | volatile | | volatile | | volatile | | volatile | |
| | volatile | matter | Sample | matter | Sample | matter | Sample | matter | Sample | matter | Sample |
| Colored Base Coating Composition | matter | amount | amount | amount | amount | amount | amount | amount | amount | amount | amount |
| chlorinated polypropylene | | | | | | | | | | | |
| resin grafted with acrylic component (A1) | | | | | | | | | | | |
| A1-1 | 42.0 | 42.4 | 101 | 37.8 | 90 | 47.5 | 113 | 27.7 | 66 | 57.5 | 137 |
| A1-2 | 42.0 | | | | | | | | | | |
| A1-3 | 42.0 | | | | | | | | | | |
| OH group-containing acrylic | | | | | | | | | | | |
| resin (A2) | | | | | | | | | | | |
| A2-1 | 50.0 | 40.0 | 80 | 45.0 | 90 | 35.0 | 70 | 55.0 | 110 | 25.0 | 50 |
| A2-2 | 50.0 | | | | | | | | | | |
| A2-3 | 50.0 | | | | | | | | | | |
| chlorinated polypropylene | | | | | | | | | | | |
| resin (B1) | | | | | | | | | | | |
| Superchlon 822 | 20.0 | 9.0 | 45 | 9.0 | 45 | 9.0 | 45 | 9.0 | 45 | 9.0 | 45 |
| Black pigment paste A | 35.2 | 21.5 | 61 | 21.5 | 61 | 21.5 | 61 | 21.5 | 61 | 21.5 | 61 |
| Aluminum pigment FZ-0534-60 | 60.0 | | | | | | | | | | |
| Aluminum pigment FZ-U40C | 55.0 | | | | | | | | | | |
| Pearlescent pigment | 100.0 | | | | | | | | | | |
| White pigment paste | 60.7 | | | | | | | | | | |
| toluene | | | 40 | | 40 | | 40 | | 40 | | 40 |
| isopropyl alcohol | | | 10 | | 10 | | 10 | | 10 | | 10 |
| Total | | 112.9 | 337 | 113.3 | 345 | 113.0 | 339 | 113.2 | 332 | 113.0 | 343 |

| Content of nonvolatile matter | 33.5 | 32.8 | 33.3 | 34.1 | 32.9 |
|---|---|---|---|---|---|
| (NV %) | | | | | |
| Scope of Patent (within/out of) | within | within | within | out of | out of |
| Total amount of nonvolatile matter of A1/ | 60/40 | 55/45 | 65/35 | 45/55 | 75/25 |
| Total amount of nonvolatile matter of A2 | | | | | |
| % by mass of a nonvolatile matter of B1 based on | 8 | 8 | 8 | 8 | 8 |
| the (A1 + A2 + B1) of nonvolatile matters | | | | | |

*Black pigment paste A and White pigment paste, each contains a chlorinated polypropylene resin grafted with an acrylic component (A1).

TABLE 5

| | NV % | b-6 | | b-7 | | b-8 | | b-9 | | b-10 | |
|---|---|---|---|---|---|---|---|---|---|---|---|
| | Content of | Non- | | Non- | | Non- | | Non- | | Non- | |
| | non- | volatile | | volatile | | volatile | | volatile | | volatile | |
| | volatile | matter | Sample | matter | Sample | matter | Sample | matter | Sample | matter | Sample |
| Colored Base Coating Composition | matter | amount | amount | amount | amount | amount | amount | amount | amount | amount | amount |
| chlorinated polypropylene | | | | | | | | | | | |
| resin grafted with acrylic component (A1) | | | | | | | | | | | |
| A1-1 | 42.0 | | | | | 42.4 | 101 | 42.4 | 101 | 42.4 | 101 |
| A1-2 | 42.0 | 42.4 | 101 | | | | | | | | |
| A1-3 | 42.0 | | | 42.4 | 101 | | | | | | |
| OH group-containing acrylic | | | | | | | | | | | |
| resin (A2) | | | | | | | | | | | |
| A2-1 | 50.0 | 40.0 | 80 | 40.0 | 80 | 40.0 | 80 | 40.0 | 80 | 40.0 | 80 |
| A2-2 | 50.0 | | | | | | | | | | |
| A2-3 | 50.0 | | | | | | | | | | |
| chlorinated polypropylene | | | | | | | | | | | |
| resin (B1) | | | | | | | | | | | |
| Superchlon 822 | 20.0 | 9.0 | 45 | 9.0 | 45 | | | 5.0 | 25 | 15.0 | 75 |
| Black pigment paste A | 35.2 | 21.5 | 61 | 21.5 | 61 | 21.5 | 61 | 21.5 | 61 | 21.5 | 61 |
| Aluminum pigment FZ-0534-60 | 60.0 | | | | | | | | | | |
| Aluminum pigment FZ-U40C | 55.0 | | | | | | | | | | |
| Pearlescent pigment | 100.0 | | | | | | | | | | |
| White pigment paste | 60.7 | | | | | | | | | | |
| toluene | | | 40 | | 40 | | 40 | | 40 | | 40 |
| isopropyl alcohol | | | 10 | | 10 | | 10 | | 10 | | 10 |
| Total | | 112.9 | 337 | 112.9 | 337 | 103.9 | 292 | 108.9 | 317 | 118.9 | 367 |

| Content of nonvolatile matter | 33.5 | 33.5 | 35.6 | 34.4 | 32.4 |
|---|---|---|---|---|---|
| (NV %) | | | | | |
| Scope of Patent (within/out of) | within | out of | out of | within | within |
| Total amount of nonvolatile matter of A1/ | 60/40 | 60/40 | 60/40 | 60/40 | 60/40 |
| Total amount of nonvolatile matter of A2 | | | | | |
| % by mass of a nonvolatile matter of B1 based on | 8 | 8 | 0 | 5 | 13 |
| the (A1 + A2 + B1) of nonvolatile matters | | | | | |

*Black pigment paste A and White pigment paste, each contains a chlorinated polypropylene resin grafted with an acrylic component (A1).

TABLE 6

| | NV % | b-11 | | b-12 | | b-13 | |
|---|---|---|---|---|---|---|---|
| | Content of | Nonvolatile | | Nonvolatile | | Nonvolatile | |
| | nonvolatile | matter | Sample | matter | Sample | matter | Sample |
| Colored Base Coating Composition | matter | amount | amount | amount | amount | amount | amount |
| chlorinated polypropylene resin | | | | | | | |
| grafted with acrylic component (A1) | | | | | | | |
| A1-1 | 42.0 | 42.4 | 101 | 42.4 | 101 | 42.4 | 101 |
| A1-2 | 42.0 | | | | | | |
| A1-3 | 42.0 | | | | | | |
| OH group-containing acrylic | | | | | | | |
| resin (A2) | | | | | | | |
| A2-1 | 50.0 | 40.0 | 80 | | | | |
| A2-2 | 50.0 | | | 40.0 | 80 | | |
| A2-3 | 50.0 | | | | | 40.0 | 80 |
| chlorinated polypropylene resin | | | | | | | |
| (B1) | | | | | | | |
| Superchlon 822 | 20.0 | 20.0 | 100 | 9.0 | 45 | 9.0 | 45 |
| Black pigment paste A | 35.2 | 21.5 | 61 | 21.5 | 61 | 21.5 | 61 |
| Aluminum pigment FZ-0534-60 | 60.0 | | | | | | |
| Aluminum pigment FZ-U40C | 55.0 | | | | | | |
| Pearlescent pigment | 100.0 | | | | | | |
| White pigment paste | 60.7 | | | | | | |
| toluene | | | 40 | | 40 | | 40 |
| isopropyl alcohol | | | 10 | | 10 | | 10 |
| Total | | 123.9 | 392 | 112.9 | 337 | 112.9 | 337 |

| Content of nonvolatile matter | 31.6 | 33.5 | 33.5 |
|---|---|---|---|
| (NV %) | | | |
| Scope of Patent (within/out of) | out of | within | within |
| Total amount of nonvolatile matter of A1/ | 60/40 | 60/40 | 60/40 |
| Total amount of nonvolatile matter of A2 | | | |
| % by mass of a nonvolatile matter of B1 based | 16 | 8 | 8 |
| on the (A1 + A2 + B1) of nonvolatile matters | | | |

*Black pigment paste A and White pigment paste, each contains a chlorinated polypropylene resin grafted with an acrylic component (A1).

TABLE 7

| | NV % | s-1 | | w-1 | | p-1 | |
|---|---|---|---|---|---|---|---|
| | Content of | Nonvolatile | | Nonvolatile | | Nonvolatile | |
| | nonvolatile | matter | Sample | matter | Sample | matter | Sample |
| Colored Base Coating Composition | matter | amount | amount | amount | amount | amount | amount |
| chlorinated polypropylene resin | | | | | | | |
| grafted with acrylic component (A1) | | | | | | | |
| A1-1 | 42.0 | 60.1 | 143 | | | 60.1 | 143 |
| A1-2 | 42.0 | | | | | | |
| A1-3 | 42.0 | | | | | | |
| OH group-containing acrylic | | | | | | | |
| resin (A2) | | | | | | | |
| A2-1 | 50.0 | 40.0 | 80 | 40.0 | 80 | 40.0 | 80 |
| A2-2 | 50.0 | | | | | | |
| A2-3 | 50.0 | | | | | | |
| chlorinated polypropylene resin | | | | | | | |
| (B1) | | | | | | | |
| Superchlon 822 | 20.0 | 9.0 | 45 | 9.0 | 45 | 9.0 | 45 |
| Black pigment paste A | 35.2 | | | | | | |
| Aluminum pigment FZ-0534-60 | 60.0 | 6 | 10 | | | | |
| Aluminum pigment FZ-U40C | 55.0 | 3.3 | 6 | | | | |
| Pearlescent pigment | 100.0 | | | | | 7.0 | 7 |
| White pigment paste | 60.7 | | | 202.1 | 333 | | |
| toluene | | | 73 | | 62 | | 40 |
| isopropyl alcohol | | | | | | | 10 |
| Total | | 118.4 | 357 | 251.1 | 520 | 112.1 | 305 |

| Content of nonvolatile matter | 33.2 | 48.3 | 36.8 |
|---|---|---|---|
| (NV %) | | | |
| Scope of Patent (within/out of) | within | within | within |
| Total amount of nonvolatile matter of A1/ | 60/40 | 60/40 | 60/40 |
| Total amount of nonvolatile matter of A2 | | | |
| % by mass of a nonvolatile matter of B1 based | 8 | 8 | 8 |
| on the (A1 + A2 + B1) of nonvolatile matters | | | |

*Black pigment paste A and White pigment paste, each contains a chlorinated polypropylene resin grafted with an acrylic component (A1).

TABLE 8

| | NV % | h-1 | | h-2 | | h-3 | |
|---|---|---|---|---|---|---|---|
| | Content of | Nonvolatile | | Nonvolatile | | Nonvolatile | |
| Colored Base Coating | nonvolatile | matter | Sample | matter | Sample | matter | Sample |
| Composition | matter | amount | amount | amount | amount | amount | amount |
| acrylic resin | | | | | | | |
| Almatex L-1043 | 40.0 | 50.0 | 125 | 50.0 | 125 | 50.0 | 125 |
| CAB resin | | | | | | | |
| CAB 381-2 | 20.0 | 50.0 | 250 | 50.0 | 250 | 50.0 | 250 |
| chlorinated polypropylene resin | | | | | | | |
| Superchlon 822 | 20.0 | 0 | 0 | 9.6 | 48 | 19.2 | 96 |
| Black pigment paste B | 41.5 | 21.6 | 52 | 21.6 | 52 | 21.6 | 52 |
| ethyl acetate ester | | | 16 | | 16 | | 16 |
| butyl acetate ester | | | 38 | | 38 | | 38 |
| Total | | 121.6 | 481 | 131.2 | 529 | 140.8 | 577 |

| | | | |
|---|---|---|---|
| Content of nonvolatile matter | 25.3 | 24.8 | 24.4 |
| (NV %) | | | |

TABLE 9

| | NV % | UV-1 | | UV-2 | | UV-3 | | UV-4 | |
|---|---|---|---|---|---|---|---|---|---|
| | Content of | Nonvolatile | | Nonvolatile | | Nonvolatile | | Nonvolatile | |
| Clear Coating | nonvolatile | matter | Sample | matter | Sample | matter | Sample | matter | Sample |
| Composition | matter | amount | amount | amount | amount | amount | amount | amount | amount |
| urethane acrylate (C) | | | | | | | | | |
| LR8987-100 | 100 | 21.5 | 21.5 | 40.0 | 40.0 | 40.0 | 40.0 | 15.0 | 15.0 |
| TO-2284 | 100 | | | | | | | | |
| UA-1 | 100 | | | | | | | | |
| H-7 | 100 | | | | | | | | |
| Photopolymerizable | | | | | | | | | |
| monomer (D) | | | | | | | | | |
| D1:1.9ND-A | 100 | 78.5 | 78.5 | 60.0 | 60.0 | 60.0 | 60.0 | 85.0 | 85.0 |
| CAB resin (B2) | | | | | | | | | |
| CAB551-0.05 | 100 | 1.0 | 1.0 | 1.0 | 1.0 | 1.0 | 1.0 | 1.0 | 1.0 |
| Photopolymerization | | | | | | | | | |
| initiator | | | | | | | | | |
| Darocur MBF | 100 | 2.4 | 2.4 | 2.4 | 2.4 | 2.4 | 2.4 | 2.4 | 2.4 |
| Lucirin TPO | 100 | 1.0 | 1.0 | 1.0 | 1.0 | 1.0 | 1.0 | 1.0 | 1.0 |
| UV absorbent: | 85 | 0.8 | 1.0 | 0.8 | 1.0 | 0.8 | 1.0 | 0.8 | 1.0 |
| Tinuvin 400 | | | | | | | | | |
| Light stabilizer: | 100 | 1.0 | 1.0 | 1.0 | 1.0 | 1.0 | 1.0 | 1.0 | 1.0 |
| Tinuvin 292 | | | | | | | | | |
| Surface controller: | 90 | 0.1 | 0.1 | 0.1 | 0.1 | 0.1 | 0.1 | 0.1 | 0.1 |
| BYK333 | | | | | | | | | |
| butyl acetate ester | | | | | | | 20 | | |
| Total | | 106.3 | 106.5 | 106.3 | 106.5 | 106.3 | 126.5 | 106.3 | 106.5 |

TABLE 10

| | NV % | UV-5 | | | | | | | | | |
|---|---|---|---|---|---|---|---|---|---|---|---|
| | Content of | Non- | | UV-6 | | UV-7 | | UV-8 | | UV-9 | |
| | non- | volatile | | Nonvolatile | | Nonvolatile | | Nonvolatile | | Nonvolatile | |
| Clear Coating | volatile | matter | Sample | matter | Sample | matter | Sample | matter | Sample | matter | Sample |
| Composition | matter | amount | amount | amount | amount | amount | amount | amount | amount | amount | amount |
| urethane acrylate (C) | | | | | | | | | | | |
| LR8987-100 | 100 | 5.0 | 5.0 | 45.0 | 45.0 | | | | | | |
| TO-2284 | 100 | | | | | 21.5 | 21.5 | | | | |
| UA-1 | 100 | | | | | | | 21.5 | 21.5 | | |
| H-7 | 100 | | | | | | | | | 21.5 | 21.5 |
| Photopolymerizable | | | | | | | | | | | |
| monomer (D) | | | | | | | | | | | |
| D1:1.9ND-A | 100 | 95.0 | 95.0 | 55.0 | 55.0 | 78.5 | 78.5 | 78.5 | 78.5 | 78.5 | 78.5 |
| CAB resin (B2) | | | | | | | | | | | |
| CAB551-0.05 | 100 | 1.0 | 1.0 | 1.0 | 1.0 | 1.0 | 1.0 | 1.0 | 1.0 | 1.0 | 1.0 |
| Photopolymerization | | | | | | | | | | | |
| initiator | | | | | | | | | | | |
| Darocur MBF | 100 | 2.4 | 2.4 | 2.4 | 2.4 | 2.4 | 2.4 | 2.4 | 2.4 | 2.4 | 2.4 |
| Lucirin TPO | 100 | 1.0 | 1.0 | 1.0 | 1.0 | 1.0 | 1.0 | 1.0 | 1.0 | 1.0 | 1.0 |
| UV absorbent: | 85 | 0.8 | 1.0 | 0.8 | 1.0 | 0.8 | 1.0 | 0.8 | 1.0 | 0.8 | 1.0 |
| Tinuvin 400 | | | | | | | | | | | |
| Light stabilizer: | 100 | 1.0 | 1.0 | 1.0 | 1.0 | 1.0 | 1.0 | 1.0 | 1.0 | 1.0 | 1.0 |
| Tinuvin 292 | | | | | | | | | | | |
| Surface controller: | 90 | 0.1 | 0.1 | 0.1 | 0.1 | 0.1 | 0.1 | 0.1 | 0.1 | 0.1 | 0.1 |
| BYK333 | | | | | | | | | | | |
| butyl acetate ester | | | | | | | | | | | |
| Total | | 106.3 | 106.5 | 106.3 | 106.5 | 106.3 | 106.5 | 106.3 | 106.5 | 106.3 | 106.5 |

TABLE 11

| | | Black pigment | | Black pigment | |
|---|---|---|---|---|---|
| | | paste A | | paste B | |
| | NV % | Non- | | Non- | |
| | Content of | volatile | | volatile | |
| | nonvolatile | matter | Sample | matter | Sample |
| | matter | amount | amount | amount | amount |
| Raven 1255 | 100 | 100.0 | 100 | | |
| Monarch 1300 | 100 | | | 100.0 | 100 |
| A1-1 | 42 | 420.0 | 1000 | | |
| Arotan 2054 | 50 | | | 243.0 | 486 |
| toluene | | | 170 | | |
| xylene | | | 170 | | |
| butyl acetate ester | | | 38 | | 120 |
| amyl acetate ester | | | | | 60 |
| PGM-AC | | | | | 60 |
| Total | | 520.0 | 1478 | 343.0 | 826 |

| | | |
|---|---|---|
| Content of nonvolatile | 35.2 | 41.5 |
| matter (NV %) | | |

Note)
Raven 1255: black pigment, tradename manufactured by Columbian Carbon Japan Co., Ltd.
Monarch 1300: black pigment, tradename manufactured by Cabot Specialty Chemicals, Inc.
Arotan 2054: acrylic resin, tradename manufactured by Nippon Shokubai Co., Ltd.
PGM-AC: propylene glycol monomethyl ether acetate

TABLE 12

White pigment
paste

| | NV % | Non- | |
|---|---|---|---|
| | Content of | volatile | |
| | nonvolatile | matter | Sample |
| | matter | amount | amount |
| CR95 | 100 | 100.0 | 100 |
| A1-1 | 42 | 42.0 | 100 |
| toluene | | | 12 |
| xylene | | | 19 |
| butyl acetate ester | | | 3 |
| Total | | 142.0 | 234 |

| | |
|---|---|
| Content of nonvolatile | 60.7 |
| matter (NV %) | |

Note)
CR95: titanium oxide, tradename manufactured by Ishihara Sangyo Kaisha Ltd.

### First to Thirteenth Examples, First to Thirteenth Comparative Examples and First to Fourth Reference Examples

A substrate which is a PP resin plate having a size of 70 mm×100 mm and a thickness of 3 mm was prepared and the surface thereof was cleaned with isopropyl alcohol. On the surface of the substrate, the above-prepared colored base coating composition was coated by a spraying method so that the dried coat has a thickness of 15 μm. Then, the resultant coat was dried at 70° C. by blowing heated air thereto to thereby obtain the colored base coat. On the obtained colored base coat, the above-prepared clear coating composition was coated by a spraying method so that the cured coat has a thickness of 30 μm and by irradiation with a UV ray having a light amount of 2000 mJ/cm², the multilayer coat was simultaneously cured.

The obtained result is shown in Table 13.

A nonvolatile matter in the colored base coat during the spraying of the clear coating composition, the coating temperature and the coating viscosity during the coating of the clear coating composition, and the atmosphere (oxygen content) during the simultaneous curing of the multilayer coat by irradiation with a UV ray, are also shown in Table 13.

The irradiation of a UV ray was performed using D bulb (metal halide lamp) (MH) and H bulb (high pressure mercury vapor lamp) (Hg) (both, trade names; manufactured by Fusion UV Systems, Inc.). The integrated light amount of a UV ray during the combination use of MH-Hg was respectively 1000 mJ/cm² each, total 2000 mJ/cm². Used actinometer was “POWER PUCK” (trade name; manufactured by EIT, Inc.).

TABLE 13

| | | | | | | | | | | | | | | | Compar- | Compar- |
|---|---|---|---|---|---|---|---|---|---|---|---|---|---|---|---|---|
| | | Exam- | Exam- | Exam- | Exam- | Exam- | Exam- | Exam- | Exam- | Exam- | Exam- | Example | Example | Example | ative | ative |
| | | ple 1 | ple 2 | ple 3 | ple 4 | ple 5 | ple 6 | ple 7 | ple 8 | ple 9 | ple 10 | 11 | 12 | 13 | Example 1 | Example 2 |
| Compo- | Type of colored base coating composition | b-1 | b-1 | b-1 | s-1 | w-1 | b-2 | b-3 | b-9 | b-10 | b-6 | b-1/p-1 | b-12 | b-13 | b-4 | b-5 |
| sition | Type of clear coating composition | UV1 | UV1 | UV2 | UV1 | UV1 | UV3 | UV4 | UV1 | UV1 | UV1 | UV1 | UV1 | UV1 | UV1 | UV4 |
| | Content of nonvolatile matter | 85 | 75 | 85 | 85 | 85 | 85 | 85 | 95 | 95 | 85 | 85 | 85 | 85 | 70 | 70 |
| | in colored base coat (%) | | | | | | | | | | | | | | | |
| | Retention time (sec) at 70° C. of colored base coat | 80 | 60 | 80 | 80 | 80 | 80 | 80 | 120 | 120 | 80 | 80 | 80 | 80 | 55 | 55 |
| | Clear coating viscosity | 27 | 27 | 36 | 27 | 27 | 42 | 19 | 27 | 27 | 27 | 27 | 27 | 27 | 27 | 19 |
| | Coating temperature of clear coating | 40 | 40 | 65 | 40 | 40 | 60 | 40 | 40 | 40 | 40 | 40 | 40 | 40 | 40 | 40 |
| | composition during coating (° C.) | | | | | | | | | | | | | | | |
| | Oxygen content in a curing atomosphere (%) | 1 | 2 | 5 | 1 | 1 | 1 | 1 | 1 | 1 | 1 | 1 | 1 | 1 | 1 | 1 |
| | Type of UV irradiating lamp | MH | MH | Hg | MH | MH | MH | MH | MH | MH | MH | MH | MH | MH | MH | MH |
| Eval- | Solvent resistance | ◯ | ◯ | ◯ | ◯ | ◯ | ◯ | ◯ | ◯ | ◯ | ◯ | ◯ | ◯ | ◯ | ◯ | ◯ |
| uation | Coat appearance(distinctness meter) | ◯ | ◯ | ◯ | ◯ | ◯ | ◯ | ◯ | ◯ | ◯ | ◯ | ◯ | ◯ | ◯ | Δ | ◯ |
| | Adhesion | | | | | | | | | | | | | | | |
| | Base coat and substrate | ◯ | ◯ | ◯ | ◯ | ◯ | ◯ | ◯ | ◯ | ◯ | ◯ | ◯ | ◯ | ◯ | Δ | ◯ |
| | Cohesive failure of base coat | ◯ | ◯ | ◯ | ◯ | ◯ | ◯ | ◯ | ◯ | ◯ | ◯ | ◯ | ◯ | ◯ | ◯ | ◯ |
| | Interlayer between base coat and clear coat | ◯ | ◯ | ◯ | ◯ | ◯ | ◯ | ◯ | ◯ | ◯ | ◯ | ◯ | ◯ | ◯ | ◯ | Δ |
| | Coat hardness (Pencil hardness) | ◯ | ◯ | ◯ | ◯ | ◯ | ◯ | ◯ | ◯ | ◯ | ◯ | ◯ | ◯ | ◯ | ◯ | ◯ |
| | Flex resistance of colored base coat | ◯ | ◯ | ◯ | ◯ | ◯ | ◯ | ◯ | ◯ | ◯ | ◯ | ◯ | ◯ | ◯ | ◯ | ◯ |

| | | Com- | Com- | Com- | Com- | Com- | Com- | Com- | Com- | | | | | | | |
|---|---|---|---|---|---|---|---|---|---|---|---|---|---|---|---|---|
| | | par- | par- | par- | par- | par- | par- | par- | par- | Compar- | Compar- | Compar- | | | | |
| | | ative | ative | ative | ative | ative | ative | ative | ative | ative | ative | ative | | | | |
| | | Exam- | Exam- | Exam- | Exam- | Exam- | Exam- | Exam- | Exam- | Example | Example | Example | Reference | Reference | Reference | Reference |
| | | ple 3 | ple 4 | ple 5 | ple 6 | ple 7 | ple 8 | ple 9 | ple 10 | 11 | 12 | 13 | Example 1 | Example 2 | Example 3 | Example 4 |
| Compo- | Type of colored base coating composition | b-7 | b-8 | b-11 | b-1 | b-1 | b-1 | b-1 | b-1 | b-1 | b-1 | b-1 | h-1 | h-2 | h-3 | R308TG^{1} |
| sition | Type of clear coating composition | UV1 | UV1 | UV1 | UV5 | UV7 | UV8 | UV9 | UV1 | UV2 | UV1 | UV6 | UV1 | UV1 | UV1 | UV1 |
| | Content of nonvolatile matter | 70 | 70 | 85 | 85 | 85 | 85 | 85 | 65 | 85 | 85 | 85 | 85 | 85 | 85 | 65 |
| | in colored base coat (%) | | | | | | | | | | | | | | | |
| | Retention time(sec) at 70° C. of colored | 55 | 55 | 80 | 80 | 80 | 80 | 80 | 45 | 80 | 80 | 80 | 80 | 80 | 80 | 80 |
| | base coat | | | | | | | | | | | | | | | |
| | Clear coating viscosity | 27 | 27 | 27 | 16 | 33 | 32 | 26 | 27 | 62 | 27 | 56 | 27 | 27 | 27 | 27 |
| | Coating temperature of clear coating | 40 | 40 | 40 | 25 | 40 | 40 | 60 | 40 | 50 | 40 | 65 | 40 | 40 | 40 | 40 |
| | composition during coating (° C.) | | | | | | | | | | | | | | | |
| | Oxygen content in a curing atomosphere (%) | 1 | 1 | 1 | 5 | 1 | 1 | 1 | 1 | 5 | 7 | 1 | 1 | 1 | 1 | 1 |
| | Type of UV irradiating lamp | MH | MH | MH | MH + | MH | MH | MH | MH | Hg | MH | MH | MH | MH | MH | MH |
| | | | | | Hg | | | | | | | | | | | |
| Eval- | Solvent resistance | ◯ | ◯ | ◯ | Δ | Δ | ◯ | ◯ | ◯ | ◯ | X | ◯ | ◯ | ◯ | ◯ | ◯ |
| uation | Coat appearance (distinctness meter) | Δ | Δ | ◯ | ◯ | ◯ | ◯ | Δ | X | X | ◯ | X | ◯ | X | X | X |
| | Adhesion | | | | | | | | | | | | | | | |
| | Base coat and substrate | ◯ | Δ | ◯ | ◯ | ◯ | ◯ | ◯ | ◯ | ◯ | ◯ | ◯ | X | Δ | ◯ | ◯ |
| | Cohesive failure of base coat | ◯ | ◯ | ◯ | ◯ | ◯ | ◯ | ◯ | Δ | ◯ | ◯ | ◯ | ◯ | ◯ | ◯ | Δ |
| | Interlayer between base coat and clear coat | ◯ | ◯ | Δ | ◯ | Δ | Δ | ◯ | ◯ | ◯ | X | ◯ | ◯ | Δ | X | X |
| | Coat hardness (Pencil hardness) | ◯ | ◯ | ◯ | Δ | Δ | ◯ | ◯ | ◯ | ◯ | X | ◯ | ◯ | ◯ | ◯ | ◯ |
| | Flex resistance of colored base coat | ◯ | ◯ | ◯ | ◯ | ◯ | ◯ | ◯ | ◯ | ◯ | ◯ | ◯ | X | X | X | ◯ |

^{1}base coating composition for soft substrate, manufactured by Nippon Bee Chemical Co., Ltd. (proven in side molding and mud guard for automobile)

The measurement items and the evaluation of the coat performance in the examples and the comparative examples were performed according to the following methods.

### <Nonvolatile Matter in Colored Base Coat>

A colored base coating composition which is an object of the test was coated on an aluminum foil (mass: X) so that the dried coat has a predetermined thickness (in the following examples and comparative examples, 15 μm) and the resultant coat was maintained at a drying temperature of 70° C. for a drying time shown in Table 13. Immediately thereafter, for preventing the escape of a volatile portion, the aluminum foil was folded and weighed (mass (Y) thereof). Next, the folded aluminum foil was spread.

According to JIS-K-5601-1-2, the spread foil was heated at 105° C. for 3 hours and the mass (Z) thereof was measured. From the following equation, the value (W) was obtained by the calculation as the amount of a nonvolatile matter in the colored base coat.

$$W ( \% ) = \frac{Z - X}{Y - X} \times 100 \qquad < Equation 3 >$$

### <Coating Viscosity of Clear Coating Composition>

A clear coating composition which is an object of the test was coated at a temperature shown in Table 13 on a tin plate so that the dried coat has a thickness of 30 μm and the resultant coat was allowed to stand for 2 minutes. Immediately thereafter, a portion of the clear coat was peeled off and was subjected to a measurement of the viscosity thereof at the same temperature as that of the clear coating composition at that time using an R-type viscometer (trade name: RE550L type; manufactured by Toki Sangyo Co., Ltd.), to thereby report the measured value as the coating viscosity of that clear coating composition at that temperature.

### <Solvent Resistance>

With a flannel cloth containing acetone, the surface of the test piece was rubbed for 30 reciprocatings, and then the state of the surface of the coat was visually observed, to thereby evaluate the coat according to the following evaluation criteria.
◯: No particular
Δ: Dulling was observed on the surface of the coat.
×: The surface of the coat was dissolved.

### <Appearance of Coat>

Using a gloss and distinctness meter (trade name: PGD-Iv type; manufactured by Japan Color Research Institute), the distinctness of the coat surface was measured and it was evaluated according to the following evaluation criteria.
◯: PGD value ≧0.4
Δ: PGD value 0.3 to 0.2
×: PGD value ≦0.1

### <Adhesion>

In the obtained multilayer coat, cuts which reach perpendicularly the surface of the substrate were inserted tessellatedly with an interval of 1 mm in both lengthwise and cross directions on the coat surface to form 100 rectangular solids of the coat, and an adhesive tape was stuck on the upper surfaces of the 100 rectangular solids to attempt to peel rapidly off the 100 rectangular solids from the surface of the substrate. After this attempt, the number of the rectangular solids which have remained on the surface of the substrate without being peeled off, was counted and the adhesion of the multilayer coat was evaluated according to the following criteria.
◯: remained rectangular solids 100/100 (original rectangular solids)
Δ: remained rectangular solids 99 to 90/100 (original rectangular solids)
×remained rectangular solids less than 90/100 (original rectangular solids)

### <Coat Hardness (Pencil Hardness)>

Using a series of pencils (trade name: Uni; Mitsubishi Pencil Co., Ltd) having gradually harder cores one by one in which the top of the core has a flat surface, the flat top of the pencil core was butted to the coat surface in such a manner that the pencil and the coat surface made an angle of 45° between them, and the coat surface was scratched by the pencil. According to the hardness of a pencil core by which a scratch mark reaching the surface of the substrate was obtained, the hardness of the coat was evaluated according to the following criteria.
◯: F or harder
Δ: HB to B
×2B or softer

### <Flex Resistance>

The test for the flex resistance was performed by a “cylindrical mandrel method” according to JIS-K5601-5-1.

A polypropylene resin plate having a size of 25 mm (w)×150 mm (1)×3 mm (t) was cleaned with isopropyl alcohol and on the resin plate, each colored base coating composition was coated, so that the thickness of the dried coat became 15 μm which is the same dried coat thickness as that of the colored base coat in the examples and the like, followed by heated air-drying the colored base coat in an atmosphere having a temperature of 70° C. to prepare the test piece.

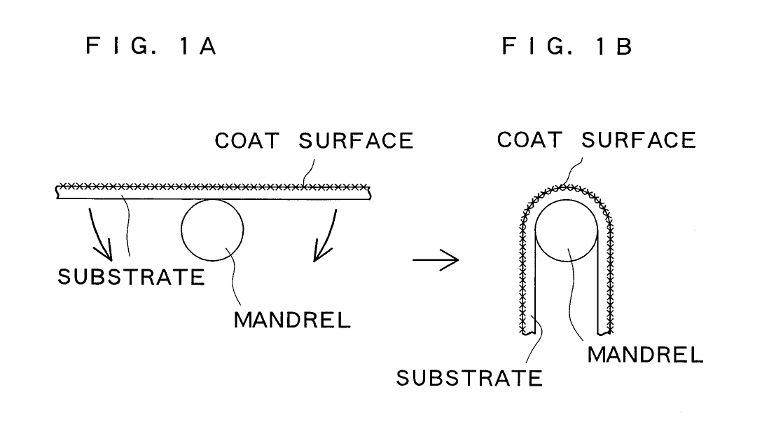

The test piece was maintained at room temperature (23±2° C.) for 3 hours and immediately thereafter, as shown in FIG. 1, was bent along a mandrel, to judge visually the presence of a cracking of the coat. For this evaluation of flex resistance, a mandrel having a diameter of 15 mm was used. The test piece was prepared so that it has a thickness of 3±0.2 mm. When the thickness of the test piece cut out of the original coated test piece was thicker than the predetermined thickness, by polishing the test piece with a sandpaper, and when was thinner than the predetermined thickness, by interposing the raw material between the test piece and the mandrel, the test piece was prepared so that it has a predetermined thickness.

Evaluation Criteria
◯: The cracking was not observed.
×: The cracking was observed.

### INDUSTRIAL APPLICABILITY

The multilayer coat forming method according to the present invention is a method for providing a multilayer coat having high appearance quality on a nonpolar resin substrate and is preferably used in coat forming for various products used in a state in which the products are exposed to the sun light in the outdoor, such as plastic material parts for an automobile exterior (for example, front grille, spoiler, wheel cap, door mirror, door handle, garnish) and the like, as well as various products, such as a housing for low current such as a housing for a radio cassette, a housing for a personal computer, a housing for a portable phone and the like.

1. A colored base coating composition comprising:
a chlorinated polyolefin resin grafted with an acrylic component (A1) in which the acrylic component has a glass transition temperature (Tg) of 60° C. or more; and
an OH group-containing acrylic resin (A2), wherein.
the chlorinated polyolefin resin grafted with the acrylic component and the OH group-containing acrylic resin have a mass ratio (A1/A2) of nonvolatile matters thereof ranging from 70/30 to 50/50; and
the colored base coating composition is of a type that is formed into a film by drying.

2. The colored base coating composition according to claim 1, further comprising:
3 to 14% by mass of a nonvolatile matter of a chlorinated polyolefin resin (B1), based on the total mass (A1+A2+B1) of the nonvolatile matters of the chlorinated polyolefin resin grafted with the acrylic component (A1), the OH group-containing acrylic resin (A2), and the chlorinated polyolefin resin (B1).

3. A clear coating composition applied on a colored base coat formed by applying the colored base coating composition according to claim 1, comprising:
an urethane acrylate resin (C) having 2.5 or more photopolymerizable functional groups in one molecule thereof and having a weight average molecular weight (Mw) of 1100 to 3000; and
a photopolymerizable monomer (D), wherein
the urethane acrylate resin and the photopolymerizable monomer have a mass ratio (C/D) of nonvolatile matters thereof ranging from 10/90 to 40/60; and
the clear coating composition is of a type that is cured into a film with an active energy ray.

4. The clear coating composition according to claim 3, further comprising:
an organic solvent having an evaporation rate of 60 or more in an amount of 25% by mass or less, based on the mass of the nonvolatile matters of the cleat coating composition.

5. The clear coating composition according to claim 3, wherein the colored base coating composition further comprises 3 to 14% by mass of a nonvolatile matter of a chlorinated polyolefin resin (B1), based on the total mass (A1+A2+B1) of the nonvolatile matters of the chlorinated polyolefin resin grafted with the acrylic component (A1), the OH group-containing acrylic resin (A2), and the chlorinated polyolefin resin (B1).

6. A multilayer coat forming method for forming a multilayer of a colored base coat formed by applying a colored base coating composition and a clear coat formed by applying a clear coating composition on a substrate made of a nonpolar resin, the method comprising:
applying the colored base coating composition on the substrate to form a colored base coat and drying the coat so that a nonvolatile matter of the coat becomes 70 to 100% by mass, wherein the colored base coating composition comprises
a chlorinated polyolefin resin grafted with an acrylic component (A1) in which the acrylic component has a glass transition temperature (Tg) of 60° C. or more, and
an OH group-containing acrylic resin (A2), wherein
the chlorinated polyolefin resin grafted with the acrylic component and the OH group-containing acrylic resin have a mass ratio (A1/A2) of nonvolatile matters thereof ranging from 70/30 to 50/50, and
the colored base coating composition is of a type that is formed into a film by
applying the clear coating composition having a coating viscosity of 15 to 50 mPa·s, on the colored base coat to form a clear coat, wherein the clear coating composition comprises
a urethane acrylate resin (C) having 2.5 or more photopolymerizable functional groups in one molecule thereof and having a weight average molecular weight (Mw) of 1100 to 3000 , and
a photopolymerizable monomer (D), wherein
the urethane acrylate resin and the photopolymerizable monomer have a mass ratio (C/D) of nonvolatile matters thereof ranging from 10/90 to 40/60, and
the clear coating composition is of a type that is cured into a film with an active energy ray; and
irradiating the clear coat with an active energy ray in an atmosphere having an oxygen content of 5% by mass or less to cure the clear coat.

7. The multilayer coat forming method according to claim 6, wherein the temperature of the clear coating composition during the coating is controlled within the range of 20 to 65° C.

8. The multilayer coat forming method according to claim 6, wherein the colored base coating composition further comprises 3 to 14% by mass of a nonvolatile matter of a chlorinated polyolefin resin (B1), based on the total mass (A1+A2+B1) of the nonvolatile matters of the chlorinated polyolefin resin grafted with the acrylic component (A1), the OH group-containing acrylic resin (A2), and the chlorinated polyolefin resin (B1).

9. The multilayer coat forming method according to claim 6, wherein the clear coating composition further comprises an organic solvent having an evaporation rate of 60 or more in an amount of 25% by mass or less, based on the mass of the nonvolatile matters of the clear coating composition.

10. A coated resin product comprising:
a substrate made of a nonpolar resin;
a colored base coat formed by applying a colored base coating composition on the substrate and by drying the resultant coat to form the coat as a film, wherein the colored base coating composition comprises
a chlorinated polyolefin resin grafted with an acrylic component (A1) in which the acrylic component has a glass transition temperature (Tg) of 60° C. or more, and
an OH group-containing acrylic resin (A2), wherein
the chlorinated polyolefin resin grafted with the acrylic component and the OH group-containing acrylic resin have a mass ratio (A1/A2) of nonvolatile matters thereof ranging from 70/30 to 50/50 , and
the colored base coating composition is of a type that is formed into a film by drying; and
a clear coat formed by applying a clear coating composition on the colored base coat and by irradiating the resultant coat with an active energy ray to form the coat as a film, wherein the clear coating composition comprises
a urethane acrylate resin (C) having 2.5 or more photopolymerizable functional groups in one molecule thereof and having a weight average molecular weight (Mw) of 1100 to 3000, and
a photopolymerizable monomer (D), wherein
the urethane acrylate resin and the photopolymerizable monomer have a mass ratio (C/D) of nonvolatile matters thereof ranging from 10/90 to 40/60, and
the clear coating composition is of a type that is cured into a film with an active energy ray.

11. The coated resin product according to claim 10, wherein the nonpolar resin is a polyolefin resin.

12. The coated resin product according to claim 10, wherein the colored base coating composition further comprises 3 to 14% by mass of a nonvolatile matter of a chlorinated polyolefin resin (B1), based on the total mass (A1+A2+B1) of the nonvolatile matters of the chlorinated polyolefin resin grafted with the acrylic component (A1), the OH group-containing acrylic resin (A2), and the chlorinated polyolefin resin (B1).

13. The coated resin product according to claim 10, wherein the clear coating composition further comprises an organic solvent having an evaporation rate of 60 or more in an amount of 25% by mass or less, based on the mass of the nonvolatile matters of the clear coating composition.
